(19) United States
(12) Patent Application Publication
(10) Pub. No.: US 2026/0310121 A1
(43) Pub. Date: Oct. 8, 2026

(54) SHEET CONVEYANCE APPARATUS AND IMAGE FORMING APPARATUS

(71) Applicant: Konica Minolta, Inc., Tokyo (JP)

(72) Inventor: Naotaka UCHIDA, Aichi (JP)

(21) Appl. No.: 19/634,953

(22) Filed: Mar. 31, 2026

(30) Foreign Application Priority Data
Apr. 7, 2025 (JP) 2025-063153

(51) Int. Cl. G03G 15/23; G03G 15/00; G03G 21/16

(52) U.S. Cl. CPC G03G 15/234; G03G 15/5029; G03G 15/6579; G03G 21/1647; G03G 2215/00578; G03G 2215/00586; G03G 2215/00738

(57) ABSTRACT

Provided is a sheet conveyance apparatus that includes: a drive roller which rotates around an axial center parallel to a conveyance width direction; a plurality of driven rollers which is driven to rotate by a rotation of the drive roller; and a pressing member which presses each of the plurality of driven rollers to a side of the drive roller. A pressing force of the pressing member is variable or set such that a larger pressing force acts on an outer portion of, among the plurality of driven rollers, an end-side driven roller in the conveyance width direction than on an inner portion of the end-side driven roller in the conveyance width direction, where the end-side driven roller is located on each of both end sides of the plurality of driven rollers in the conveyance width direction.

### CROSS REFERENCE TO RELATED APPLICATIONS

Japanese Patent Application No. 2025-063153, filed on Apr. 7, 2025, including description, claims, drawings, and abstract the entire disclosure is incorporated herein by reference in its entirety.

### BACKGROUND

### Technological Field

The present invention relates to a sheet conveyance apparatus and an image forming apparatus.

### Description of Related Art

As a sheet conveyance apparatus used in an image forming apparatus of an electrophotographic method, there is known, for example, a sheet conveyance apparatus disclosed in Japanese Patent Publication Laid-Open No. 2019-26453. The sheet conveyance apparatus described in Japanese Patent Publication Laid-Open No. 2019-26453 includes a drive roller that rotates around an axial center parallel to a conveyance width direction orthogonal to a conveyance direction of a sheet (referred to as a sheet in Japanese Patent Publication Laid-Open No. 2019-26453), and a plurality of driven rollers that is driven to rotate by the rotation of the drive roller. The plurality of driven rollers cooperates with the drive roller to hold the sheet between the plurality of driven rollers and the drive roller. The sheet conveyance apparatus described in Japanese Patent Publication Laid-Open No. 2019-26453 includes a pressing member (referred to as a tension spring in Japanese Patent Publication Laid-Open No. 2019-26453) that presses each driven roller to the side of the drive roller.

The sheet conveyance apparatus described in Japanese Patent Publication Laid-Open No. 2019-26453 is configured to be switchable among a first state in which the sheet is weakly held, a second state in which the sheet is strongly held, and a third state in which the holding of the sheet is released, by changing the pressing force of the pressing member according to the type of the sheet. In a case where a sheet such as a cardboard is conveyed, the conveyance force of the sheet such as the cardboard can be increased by switching from the first state to the second state. In a case where a sheet such as thin paper is conveyed, it is possible to suppress the occurrence of wrinkles in the sheet by switching from the first state to the third state.

### SUMMARY

Incidentally, in a case where a sheet such as thin paper is conveyed in the sheet conveyance apparatus described in Japanese Patent Publication Laid-Open No. 2019-26453, the occurrence of wrinkles in the sheet can be suppressed, but the drive roller and the plurality of driven rollers are no longer involved in the conveyance of the sheet. As a result, it is not possible to assist in the conveyance of the sheet by another conveyance roller pair arranged on the immediately downstream side of the drive roller, and it is difficult to stably convey the sheet with a sufficient conveyance force.

In view of the above, an object of the present invention is to provide a sheet conveyance apparatus and an image forming apparatus each capable of stably conveying a sheet with a sufficient conveyance force while suppressing the occurrence of wrinkles and jamming of the sheet regardless of the thickness of the sheet.

An aspect of a sheet conveyance apparatus in the present invention includes:

a drive roller which rotates around an axial center parallel to a conveyance width direction orthogonal to a conveyance direction of a sheet;

a plurality of driven rollers which is disposed at intervals in the conveyance width direction, includes a roller body made of a material harder than a material constituting a roller body of the drive roller, cooperates with the drive roller to hold the sheet between the plurality of driven rollers and the drive roller, and is driven to rotate by a rotation of the drive roller; and

a pressing member which presses each of the plurality of driven rollers to a side of the drive roller.

A pressing force of the pressing member is variable or set such that a larger pressing force acts on an outer portion of, among the plurality of driven rollers, an end-side driven roller in the conveyance width direction than on an inner portion of the end-side driven roller in the conveyance width direction, where the end-side driven roller is located on each of both end sides of the plurality of driven rollers in the conveyance width direction.

An aspect of an image forming apparatus in the present invention includes the sheet conveyance apparatus described above.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic front view of an image forming apparatus according to the present embodiment;

FIG. 2 is a schematic diagram provided for describing a sheet conveyance apparatus according to the present embodiment;

FIG. 3 is a diagram illustrating a portion III in FIG. 2;

FIG. 4 is a diagram illustrating a portion IV in FIG. 3;

FIG. 5 is a diagram illustrating a portion V in FIG. 2;

FIG. 6 is a schematic enlarged diagram provided for describing an operation of a variable mechanism of the sheet conveyance apparatus according to the present embodiment, illustrating a state in which a movable portion of a solenoid is located at an approach position;

FIG. 7 is a schematic enlarged diagram provided for describing an operation of the variable mechanism of the sheet conveyance apparatus according to the present embodiment, illustrating a state in which the movable portion of the solenoid is located at a separation position;

FIG. 8 is a control block diagram of the image forming apparatus according to the present embodiment;

FIG. 9 is a schematic diagram illustrating a part of a sheet conveyance apparatus according to Variation 1 of the present embodiment; and

FIG. 10 is a schematic diagram illustrating a part of a sheet conveyance apparatus according to Variation 2 of the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present embodiment will be described with reference to the accompanying drawings. Note that, in the specification and claims of the present application, the upstream side refers to the upstream side in the conveyance direction of the sheet, and the downstream side refers to the downstream side in the conveyance direction of the sheet. The conveyance width direction is a direction orthogonal to the conveyance direction of the sheet. In the drawings, the “WD” indicates the conveyance width direction, the “WDo” indicates outward in the conveyance width direction, and “WDi” indicates inward in the conveyance width direction.

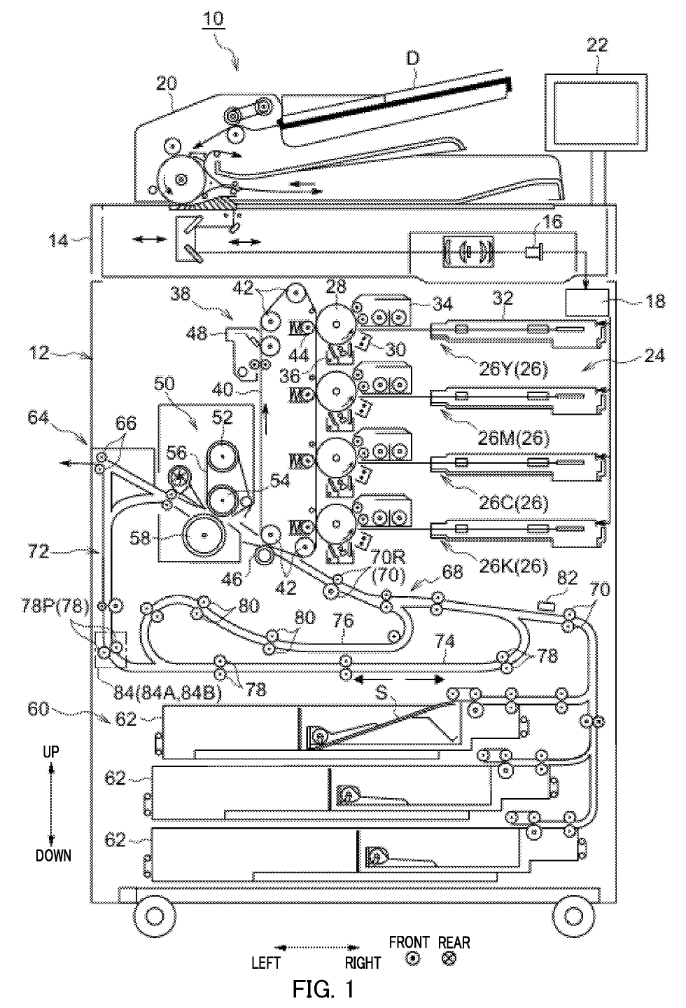

The overall configuration of an image forming apparatus 10 according to the present embodiment will be described with reference to FIG. 1. FIG. 1 is a schematic front view of the image forming apparatus 10 according to the present embodiment.

As illustrated in FIG. 1, the image forming apparatus 10 according to the present embodiment is an apparatus that forms a toner image on a sheet S as a recording medium by an electrophotographic method. The image forming apparatus 10 includes an apparatus body 12 having a box shape, and the apparatus body 12 constitutes a base frame of the image forming apparatus 10.

An image reading section 14 for reading an image of a document is provided above the apparatus body 12. The image reading section 14 optically scans a document D placed on a contact glass or the document D conveyed onto the contact glass. The image reading section 14 optically reads an image of a scanned document with a charge coupled device (CCD) sensor 16 to generate image data. In addition, in an upper portion in the apparatus body 12, an image processing section 18 is provided which performs image processing, such as shading correction and compression processing, on the image data from the image reading section 14.

As illustrated in FIG. 1, a document conveyance section 20 called an auto document feeder (ADF) is provided on the upper side of the image reading section 14 in the apparatus body 12. The document conveyance section 20 conveys the document D set in a document tray onto the contact glass of the image reading section 14. In addition, an operation display section 22 having functions as an operation section and a display section is provided on a front surface side (front side) above the apparatus body 12. The operation display section 22 is constituted by, for example, a liquid crystal display (LCD) with a touch screen. The operation display section 22 includes various kinds of operation keys such as a numeric keypad and a start key, and receives, as the operation section, various kinds of input operations by the user. The operation display section 22 displays, as the display section, various kinds of operation screens, image states, operating statuses of respective functions, and the like.

As illustrated in FIG. 1, an image forming section 24 that forms an image by an electrophotographic method is provided in the upper portion in the apparatus body 12. The image forming section 24 includes four image forming units 26Y, 26M, 26C, and 26K for forming images with color toners of yellow (Y), magenta (M), cyan (C), and black (K) components based on image data. The four image forming units 26Y, 26M, 26C, and 26K are arranged along the up-down direction.

The image forming units 26Y, 26M, 26C, and 26K for the Y component, the M component, the C component, and the K component have a similar configuration. For convenience of illustration and description, common constituent elements are denoted by the same reference signs, and when common constituent elements are distinguished from each other, the common constituent elements are illustrated by adding Y, M, C, or K to the reference signs. In FIG. 1, the reference signs are provided only for the constituent elements of the image forming unit 26Y for the Y component and the reference signs for the constituent elements of the other image forming units 26M, 26C, 26K are omitted.

The image forming unit 26 includes a photosensitive drum 28, and a charging section 30, an exposure section 32, a developing section 34, and a drum cleaning section 36 which are arranged around the photosensitive drum 28.

The photosensitive drum 28 is an image carrier for forming an image. The photosensitive drum 28 is a negative charge type organic photoreceptor in which, for example, an undercoat layer, a charge generation layer, and a charge transport layer are sequentially laminated on a periphery surface of a conductive cylindrical body made of aluminum. The photosensitive drum 28 rotates at a constant circumferential speed by the driving of a rotation motor (not illustrated).

The charging section 30 uniformly negatively charges the outer periphery surface of the photosensitive drum 28. The exposure section 32 forms an electrostatic latent image on the outer periphery surface of the photosensitive drum 28 by emitting laser light as scanning light and scanning the outer periphery surface of the photosensitive drum 28 as an image carrier while exposing the outer periphery surface. The light amount of the laser light emitted from the exposure section 32 is modulated according to image data in each color of YMCK.

The developing section 34 is, for example, a developing section of a two-component developing method. The developing section 34 forms a toner image by causing toner of each of the color components to adhere to the outer periphery surface of the photosensitive drum 28 to visualize the electrostatic latent image on the outer periphery surface of the photosensitive drum 28. In addition, the drum cleaning section 36 cleans transfer residual toner remaining on the outer periphery surface of the photosensitive drum 28 after the primary transfer. The drum cleaning section 36 includes a cleaning blade that is in sliding contact with the outer periphery surface of the photosensitive drum 28, or the like.

As illustrated in FIG. 1, a transfer section 38 for transferring the toner image onto the sheet S is provided in the upper portion in the apparatus body 12. The transfer section 38 includes an intermediate transfer belt 40 having an endless shape, a plurality of support rollers 42, a primary transfer roller 44, a secondary transfer roller 46, and a belt cleaning section 48.

The intermediate transfer belt 40 extends in the up-down direction and is stretched around the plurality of support rollers 42. The intermediate transfer belt 40 circulates by the rotation of the plurality of support rollers 42. At least one support roller 42 of the plurality of support rollers 42 is constituted by a drive roller coupled to a rotation motor (not illustrated) so as to be interlocked therewith, and the other support rollers 42 are constituted by driven rollers (free rollers).

The primary transfer roller 44 is disposed on the inner periphery surface side of the intermediate transfer belt 40 so as to face the photosensitive drum 28 of each color component. The primary transfer roller 44 cooperates with the photosensitive drum 28 to hold the intermediate transfer belt 40 therebetween. A primary transfer nip CN for transferring the toner image from the photosensitive drum 28 onto the intermediate transfer belt 40 is formed between the outer periphery surface of the primary transfer roller 44 and the outer periphery surface of the photosensitive drum 28.

The secondary transfer roller 46 is disposed on the outer periphery surface side of the intermediate transfer belt 40 so as to face a predetermined support roller 42. The secondary transfer roller 46 cooperates with the predetermined support roller 42 to hold the intermediate transfer belt 40 therebetween. A secondary transfer nip TN for transferring the toner image from the intermediate transfer belt 40 onto the sheet S is formed between the outer periphery surface of the secondary transfer roller 46 and the outer periphery surface of the predetermined support roller 42.

When the intermediate transfer belt 40 passes through the primary transfer nip CN, the toner images on the photosensitive drums 28 are sequentially primarily transferred onto the intermediate transfer belt 40 in a superposed manner. Specifically, the toner image is electrostatically transferred onto the intermediate transfer belt 40 by applying a primary transfer bias to the primary transfer roller 44 and applying an electric charge having the polarity opposite to that of the toner to the rear surface side of the intermediate transfer belt 40 (the side on which the intermediate transfer belt 40 abuts on the primary transfer roller 44).

Thereafter, when the sheet S passes through the secondary transfer nip TN, the toner image on the intermediate transfer belt 40 is secondarily transferred onto the sheet S. Specifically, the toner image is electrostatically transferred onto the sheet S and an image can be formed on the sheet S by applying a secondary transfer bias having the same polarity as the toner to the predetermined support roller 42 and applying an electric charge having the same polarity as the toner to the rear surface side of the intermediate transfer belt 40.

The belt cleaning section 48 removes transfer residual toner remaining on the surface of the intermediate transfer belt 40 after the secondary transfer. The belt cleaning section 48 includes a cleaning blade that is in sliding contact with the surface of the intermediate transfer belt 40.

As illustrated in FIG. 1, a fixer 50 for fixing the toner image onto the sheet S is provided on the downstream side of the secondary transfer nip TN in the apparatus body 12. The fixer 50 includes a heating roller 52, a fixing roller 54, a fixing belt 56 having an endless shape, and a pressure roller 58.

The heating roller 52 includes a hollow cylindrical core metal made of, for example, aluminum, iron, or stainless steel (SUS), or the like, and a heating apparatus such as a halogen lamp provided inside the core metal. In addition, the fixing roller 54 is provided at a position facing the heating roller 52. The fixing roller 54 includes: a hollow cylindrical core metal made of, for example, aluminum, iron, SUS, or the like; and a surface layer provided on the outer periphery surface of the core metal and made of, for example, silicone rubber, a silicone sponge, or the like. The fixing belt 56 is stretched around the heating roller 52 and the fixing roller 54, and is capable of circulating. The fixing belt 56 includes a base material formed of, for example, polyimide resin or the like.

The pressure roller 58 is provided at a position facing the fixing roller 54 on the outer side of the fixing belt 56, and presses against the side of the fixing roller 54 with a predetermined fixing load. The pressure roller 58 includes: a hollow cylindrical core metal made of, for example, aluminum, iron, SUS, or the like; an elastic layer provided on the outer periphery surface of the core metal and made of, for example, silicone rubber or the like; and a surface layer provided on a surface of the elastic layer and made of, for example, a PFA tube or the like. In addition, a fixing nip FN for conveying the sheet S while heating and pressurizing the sheet S is fixed between the fixing roller 54 and the pressure roller 58.

As the pressure roller 58 rotates by the driving of a rotation motor, the fixing belt 56 is driven to circulate. As the fixing belt 56 circulates, the heating roller 52 and the fixing roller 54 are driven to rotate. Thus, an unfixed toner image can be fixed onto the sheet S by conveying the sheet S while heating and pressurizing the sheet S at the fixing nip FN.

As illustrated in FIG. 1, a sheet feed section 60 for feeding the sheet S is provided in a lower portion of the apparatus body 12. The sheet feed section 60 includes a plurality of sheet feed trays 62 each of which accommodates a plurality of sheets S. Each sheet feed tray 62 accommodates the sheet S of a type set in advance according to a basis weight, a size, and the like.

A sheet ejection section 64 that ejects the sheet S, on which an image formation has been performed, to the outside of the apparatus body 12 is provided on the downstream side of the fixer 50 in the apparatus body 12. The sheet ejection section 64 includes a sheet ejection roller pair 66, and the sheet ejection roller pair 66 rotates by the driving of sheet ejection motors (not illustrated). As the sheet ejection roller pair 66 rotates, the sheet S on which an image formation has been performed can be ejected to the outside of the apparatus body 12.

As illustrated in FIG. 1, a main conveyance path 68 for conveying the sheet S is provided between the sheet feed section 60 and the sheet ejection section 64 in the apparatus body 12. The main conveyance path 68 is a path for conveying the sheet S via the secondary transfer nip TN and the fixing nip FN. A plurality of conveyance roller pairs 70 including a registration roller pair 70R is provided at positions along the main conveyance path 68 in the apparatus body 12, and the plurality of conveyance roller pairs 70 rotates by the driving of conveyance motors (not illustrated).

The sheets S accommodated in the sheet feed tray 62 are fed out one by one from the uppermost sheet S and are conveyed along the main conveyance path 68. At this time, an inclination of the sheet S is corrected by the registration roller pair 70R, and a conveyance timing of the sheet S is adjusted. Then, at the secondary transfer nip TN, the toner images on the intermediate transfer belt 40 are collectively secondarily transferred onto the sheet S, and the toner images are fixed onto the sheet S at the fixing nip FN. Thereafter, the sheet S on which the image formation has been performed is ejected to the outside of the apparatus body 12 from the sheet ejection section 64.

As illustrated in FIG. 1, a reverse conveyance path 72 for reversing and conveying the sheet S is provided above the sheet feed section 60 in the apparatus body 12. The reverse conveyance path 72 is branched from the downstream side of the fixer 50 in the main conveyance path 68. The reverse conveyance path 72 includes a switchback conveyance path 74 for switching back the sheet S. The starting end of the switchback conveyance path 74 is connected to the downstream side of the fixer 50 in the main conveyance path 68, and the terminal end of the switchback conveyance path 74 is connected to the downstream side of the registration roller pair 70R in the main conveyance path 68.

The reverse conveyance path 72 includes a return conveyance path 76 for returning the switched-back sheet S to the main conveyance path 68. The starting end of the return conveyance path 76 is connected to an intermediate portion of the switchback conveyance path 74, and the terminal end of the return conveyance path 76 is connected a portion between the registration roller pair 70R in the main conveyance path 68 and the terminal end of the switchback conveyance path 74.

A plurality of conveyance roller pairs 78 is provided at positions along the switchback conveyance path 74 in the apparatus body 12, and the plurality of conveyance roller pairs 78 rotates in the forward direction and the reverse direction by the driving of conveyance motors (not illustrated). As the plurality of conveyance roller pairs 78 rotates in the forward direction, the sheet S fed out to the switchback conveyance path 74 is conveyed toward the side of the terminal end of the switchback conveyance path 74. As the plurality of conveyance roller pairs 78 rotates in the reverse direction, the sheet S is switched back and conveyed and is fed out to the return conveyance path 76 from the side of the intermediate portion of the switchback conveyance path 74. Alternatively, as the plurality of conveyance roller pairs 78 rotates in the reverse direction, the sheet S is switched back and conveyed and is fed out from the side of the starting end of the switchback conveyance path 74 to the downstream side of the fixer 50 in the main conveyance path 68.

A plurality of conveyance roller pairs 80 is provided at positions along the return conveyance path 76 in the apparatus body 12, and the plurality of conveyance roller pairs 80 rotates by the driving of conveyance motors (not illustrated). As the plurality of conveyance roller pairs 80 rotates, the sheet S fed out to the return conveyance path 76 is conveyed toward the side of the terminal end of the return conveyance path 76 and is fed out to the upstream side of the registration roller pair 70R in the main conveyance path 68.

As illustrated in FIG. 1, a medium sensor 82 is provided in the vicinity of an upstream portion of the main conveyance path 68 in the apparatus body 12, as a medium detection section that detects information on the thickness and/or stiffness of the sheet S during conveyance. The configuration for the medium sensor 82 to detect information on the thickness and stiffness of the sheet S is, for example, a configuration known in the art described in Japanese Patent Publication Laid-Open No. 2023-87211. In addition, the image forming apparatus 10 includes a sheet conveyance apparatus 84 that conveys the sheet S on the switchback conveyance path 74, and the sheet conveyance apparatus 84 includes a predetermined conveyance roller pair 78P disposed at a bending portion of the switchback conveyance path 74 or in the vicinity thereof.

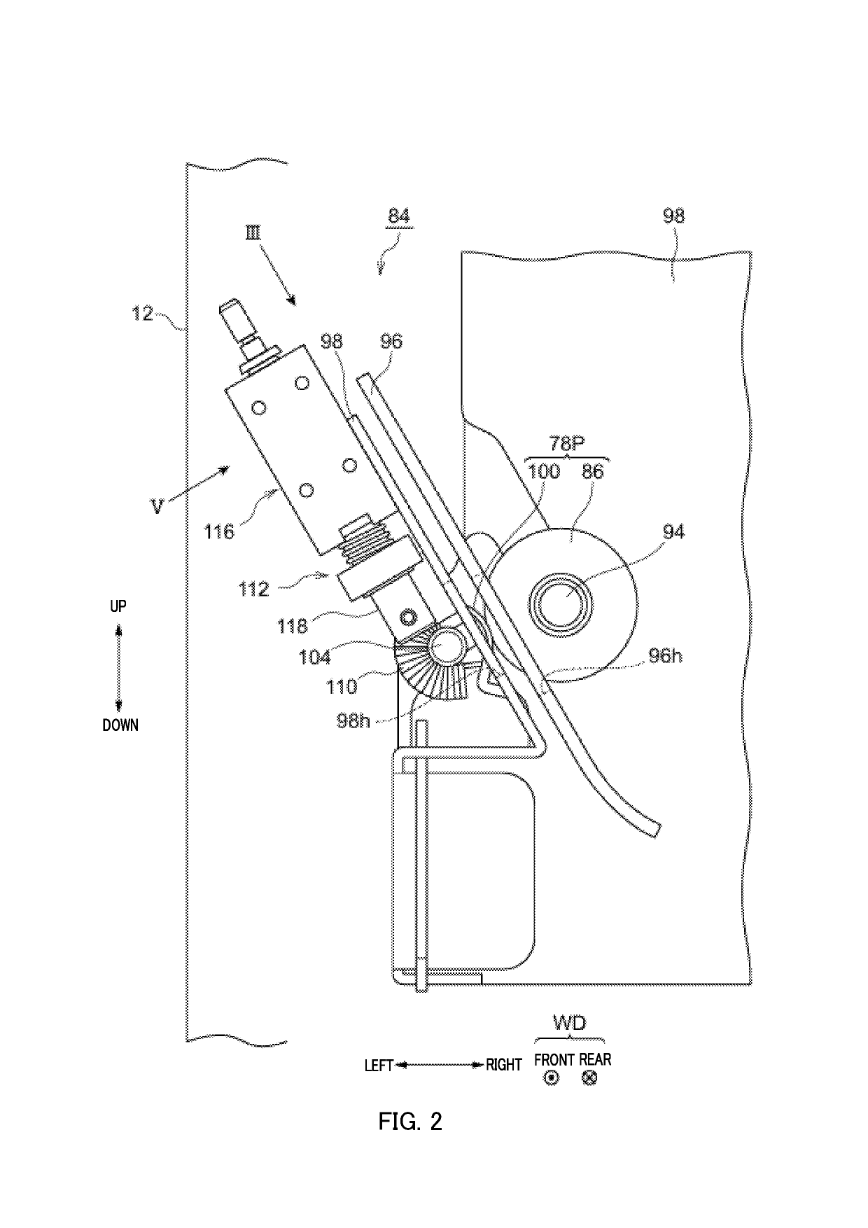

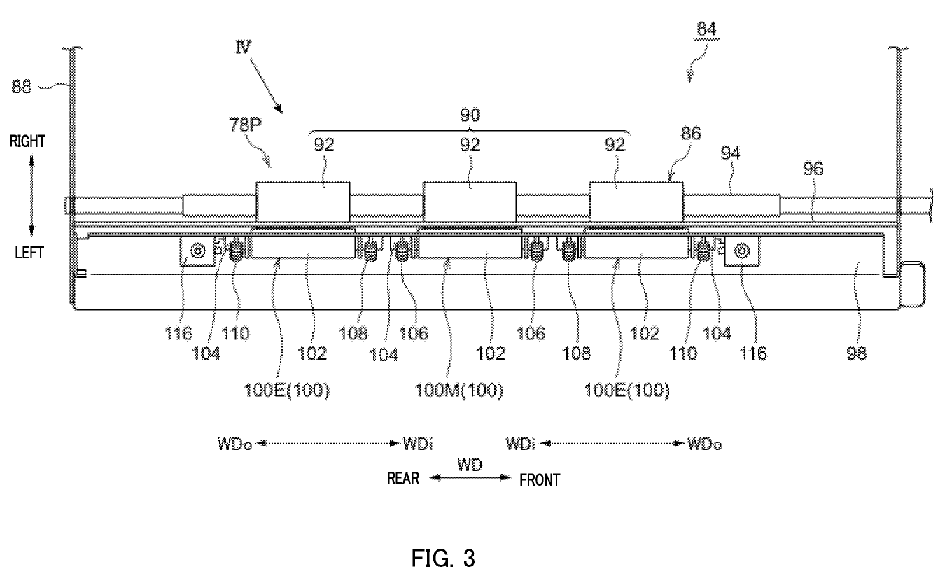

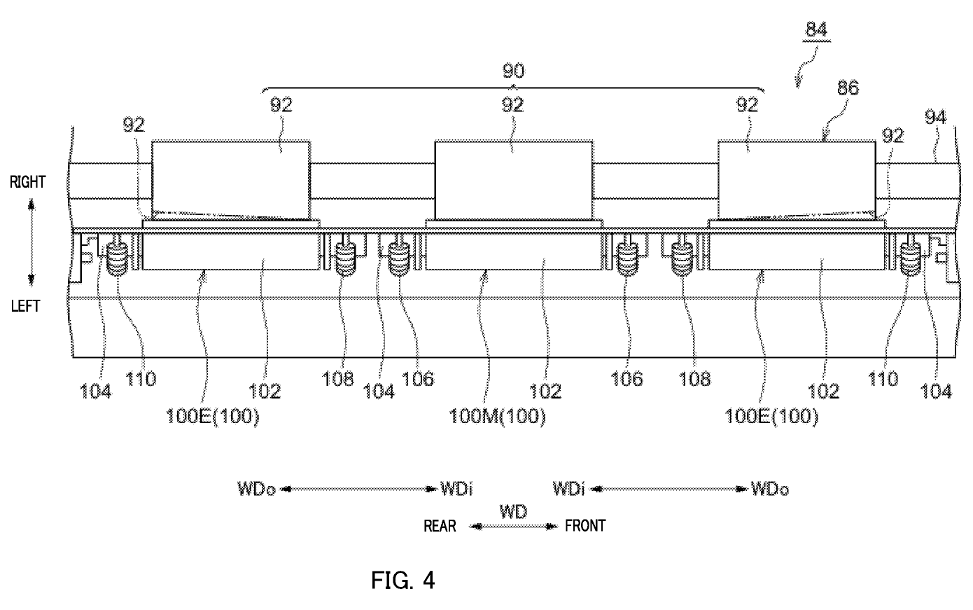

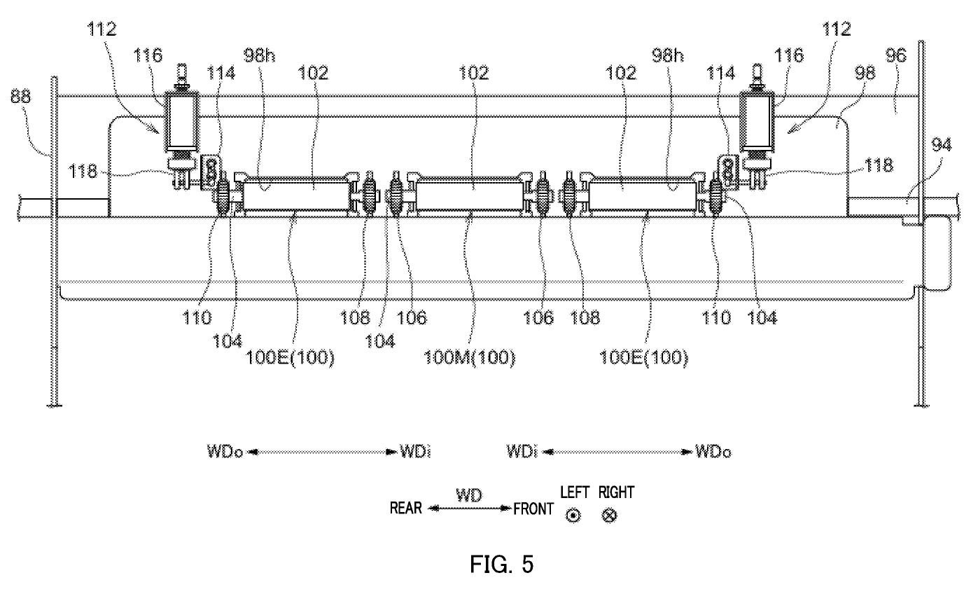

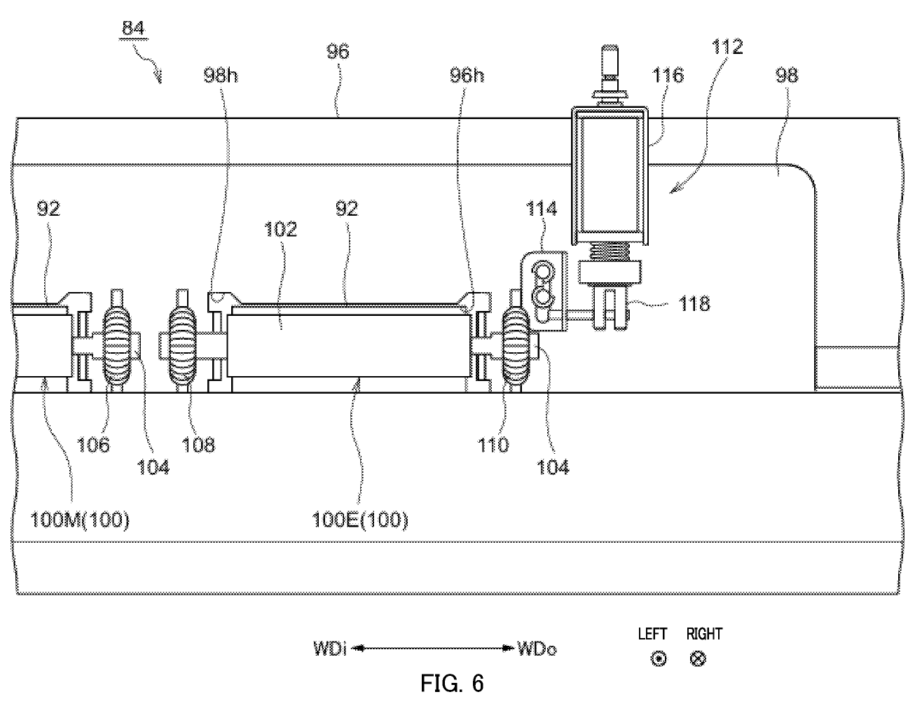

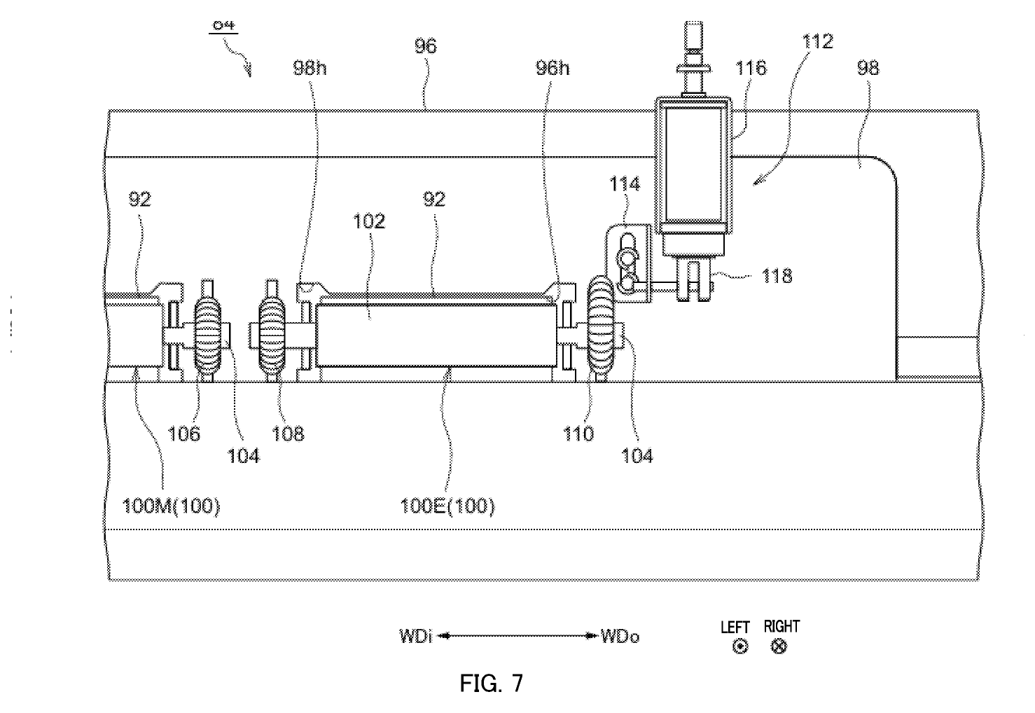

Subsequently, a specific configuration of the sheet conveyance apparatus 84 according to the present embodiment will be described with reference to FIGS. 1-7. FIG. 2 is a schematic diagram provided for describing the sheet conveyance apparatus 84 according to the present embodiment. FIG. 3 is a diagram illustrating a portion III in FIG. 2. FIG. 4 is a diagram illustrating a portion IV in FIG. 3. FIG. 5 is a diagram illustrating a V portion in FIG. 2. FIGS. 6 and 7 are schematic enlarged diagrams provided for describing operations of a variable mechanism 112 of the sheet conveyance apparatus 84 according to the present embodiment. FIG. 6 illustrates a state in which a movable portion 118 of a solenoid 116 is located at an approach position, and FIG. 7 illustrates a state in which the movable portion 118 of the solenoid 116 is located at a separation position.

As illustrated in FIGS. 1 and 2, the sheet conveyance apparatus 84 includes, as described above, the predetermined conveyance roller pair 78P rotatable in the forward direction and the reverse direction. In a case where the sheet S is conveyed toward the side of the terminal end of the switchback conveyance path 74, the predetermined conveyance roller pair 78P rotates in the forward direction. In a case where the sheet S is switched back and conveyed, the predetermined conveyance roller pair 78P rotates in the reverse direction.

As illustrated in FIGS. 1-3, the predetermined conveyance roller pair 78P includes a drive roller 86 that rotates around an axial center parallel to the conveyance width direction in the forward direction and the reverse direction by the driving of conveyance motors (not illustrated). The drive roller 86 is disposed at the bending portion of the switchback conveyance path 74 or in the vicinity thereof. The drive roller 86 is rotatably supported by a support frame 88 fixed in the apparatus body 12.

As illustrated in FIGS. 2-4, the drive roller 86 includes a roller body 90, and the roller body 90 is constituted by three divided rollers 92 having a cylindrical shape, into which the roller body 90 is divided along the conveyance width direction (the front-rear direction). Each of the divided rollers 92 is made of, for example, an elastic material such as natural rubber. The drive roller 86 includes a roller shaft 94 provided concentrically with the roller body 90, and both end portions of the roller shaft 94 are rotatably supported by the support frame 88. Note that, although the roller body 90 is constituted by the three divided rollers 92, the roller body 90 may also be constituted by two divided rollers 92 or four or more divided rollers 92. The roller body 90 is divided into the plurality of divided rollers 92, but may not also be divided.

As illustrated in FIGS. 2, 3, 5, and 6, and 6, the support frame 88 is provided with a first guide plate 96. In the first guide plate 96, a plurality of first through-holes 96h through which parts of the divided roller 92 are inserted, and the plurality of first through-holes 96h is arranged at intervals in the conveyance width direction. In addition, the support frame 88 is provided with a second guide plate 98 that faces the first guide plate 96. The first guide plate 96 and the second guide plate 98 as a guide constitute a part of the switchback conveyance path 74. In the second guide plate 98, a plurality of second through-holes 98h aligned with the first through-holes 96h of the first guide plate 96 is formed, and the plurality of second through-holes 98h is arranged at intervals in the conveyance width direction.

As illustrated in FIGS. 1, 2, 5, and 6, the predetermined conveyance roller pair 78P includes a plurality of driven rollers 100 that is driven to rotate by the rotation of the drive roller 86, and the number of the driven rollers 100 is identical to the number of the divided rollers 92. Three driven rollers 100 are arranged at intervals in the conveyance width direction at the bending portion of the switchback conveyance path 74 or in the vicinity thereof. Each of the driven rollers 100 is rotatably supported by the second guide plate 98, and a part of each of the driven rollers 100 is inserted through the second through-hole 98h of the second guide plate 98.

The plurality of driven rollers 100 cooperates with the plurality of divided rollers 92 to hold the sheet S between the plurality of driven rollers 100 and the plurality of divided rollers 92. In other words, the plurality of driven rollers 100 cooperates with the drive roller 86 to hold the sheet S between the plurality of driven rollers 100 and the drive roller 86. The first guide plate 96 and the second guide plate 98 as the guide regulate the movement of the sheet S in the thickness direction, where the sheet S is held between the drive roller 86 and the plurality of driven rollers 100.

As illustrated in FIGS. 3 to 6, the driven roller 100 includes a roller body 102 having a cylindrical shape. The roller body 102 is made of a material harder than a material constituting the divided roller 92 so as to elastically deform a part of the divided roller 92. Examples of the hard material include synthetic resin. Each of the driven rollers 100 includes a roller shaft 104 provided concentrically with the roller body 102, and both end portions of the roller shaft 104 are rotatably supported by the second guide plate 98. Each of the driven rollers 100 is allowed to be displaced in directions in which the driven roller 100 approaches and separates from the divided roller 92 with respect to the second guide plate 98. Note that, in a case where the roller body 90 is not divided into the plurality of divided rollers 92, the number of the driven rollers 100 may be two or more.

In the sheet conveyance apparatus 84, among the plurality of driven rollers 100, the driven roller 100 located on each of both end sides of the plurality of driven rollers 100 in the conveyance width direction will be referred to as an end-side driven roller 100E. Among the plurality of driven rollers 100, the driven roller 100 disposed between the two end-side driven rollers 100E will be referred to as an intermediate driven roller 100M. Of the both end portions of the roller shaft 104 of the end-side driven roller 100E, the end portion on the side close to the intermediate driven roller 100M will be referred to as an inner end portion. Of the both end portions of the roller shaft 104 of the end-side driven roller 100E, the end portion on the side far from the intermediate driven roller 100M will be referred to as an outer end portion. In the end-side driven roller 100E, the portion on the side close to the intermediate driven roller 100M will be referred to as an inner portion in the conveyance width direction. In the end-side driven roller 100E, the portion on the side far from the intermediate driven roller 100M will be referred to as an outer portion in the conveyance width direction.

As illustrated in FIGS. 3 to 6, a first tension spring 106 as a first pressing member that presses the intermediate driven roller 100M to the side of the divided roller 92 is provided at a position corresponding to each end portion of the roller shaft 104 of the intermediate driven roller 100M in the second guide plate 98. The first tension spring 106 may be regarded as a first bias member that biases the intermediate driven roller 100M to the side of the divided roller 92. Each of the first tension springs 106 comes into pressure contact with each end portion of the roller shaft 104 of the intermediate driven roller 100M by the elasticity of each of the first tension springs 106. Each end portion of each of the first tension springs 106 is locked at an appropriate position of the second guide plate 98.

A second tension spring 108 as a second pressing member that presses the inner portion of the end-side driven roller 100E in the conveyance width direction to the side of the divided roller 92 is provided at a position corresponding to the inner end portion of the roller shaft 104 of the end-side driven roller 100E in the second guide plate 98. The second tension spring 108 may be regarded as a second bias member that biases the inner portion of each end-side driven roller 100E in the conveyance width direction to the side of the divided roller 92. Each end portion of the second tension spring 108 is locked at an appropriate position of the second guide plate 98. The second tension spring 108 comes into pressure contact with the inner end portion of the roller shaft 104 of the end-side driven roller 100E by the elasticity of the second tension spring 108. The spring constant of the second tension spring 108 is the same as the spring constant of the first tension spring 106, but may also be different therefrom.

A third tension spring 110 as a third pressing member that presses the outer portion of the end-side driven roller 100E in the conveyance width direction to the side of the divided roller 92 is provided at a position corresponding to the outer end portion of the roller shaft 104 of the end-side driven roller 100E in the second guide plate 98. The third tension spring 110 may be regarded as a third bias member that biases the outer portion of the end-side driven roller 100E in the conveyance width direction to the side of the divided roller 92. One end portion of the third tension spring 110 is locked at an appropriate position of the second guide plate 98. The third tension spring 110 comes into pressure contact with the outer end portion of the roller shaft 104 of the end-side driven roller 100E by the elasticity of the third tension spring 110. The spring constant of the third tension spring 110 is the same as the spring constant of the second tension spring 108 (the spring constant of the first tension spring 106), but may also be different therefrom.

As illustrated in FIG. 5, the sheet conveyance apparatus 84 includes variable mechanisms 112 each of which varies the pressing force of the third tension spring 110 acting on the outer portion of the two end-side driven rollers 100E in the conveyance width direction, and the two variable mechanisms 112 are spaced apart from each other in the conveyance width direction. A specific configuration of the variable mechanism 112 is as follows.

As illustrated in FIGS. 5 to 7, the variable mechanism 112 includes a coupling piece 114 provided in the vicinity of the outer-side end portion of the end-side driven roller 100E in the second guide plate 98, and the coupling piece 114 is displaceable in a direction orthogonal to the roller shaft 104. The coupling piece 114 approaches and separated from the roller shaft 104 by displacement in the direction orthogonal to the roller shaft 104. The other end portion of the third tension spring 110 is locked to the coupling piece 114.

Each of the variable mechanisms 112 includes the solenoid 116 as an actuator that displaces the coupling piece 114 in the direction orthogonal to the roller shaft 104. The solenoid 116 is provided in the vicinity of the outer-side end portion of the end-side driven roller 100E in the second guide plate 98. The solenoid 116 includes the movable portion 118 movable in the direction orthogonal to the roller shaft 104, and the movable portion 118 is coupled to the coupling piece 114. The movable portion 118 moves between an approach position (the position illustrated in FIG. 6) at which the movable portion 118 has approached the roller shaft 104 and a separation position (the position illustrated in FIG. 7) at which the movable portion 118 has separated from the roller shaft 104.

When the movable portion 118 moves from the approach position to the separation position by the driving of the solenoid 116, the coupling piece 114 separates from the roller shaft 104, and the extension amount of the third tension spring 110 increases. Then, the pressing force of the third tension spring 110 acting on the outer portion of the end-side driven roller 100E in the conveyance width direction becomes larger than the pressing force of the second tension spring 108 acting on the inner portion of the end-side driven roller 100E in the conveyance width direction. In addition, when the movable portion 118 moves from the separation position to the approach position by the driving of the solenoid 116, the coupling piece 114 approaches the roller shaft 104, and the extension amount of the third tension spring 110 decreases. Then, the pressing force of the third tension spring 110 becomes the same as the pressing force of the second tension spring 108.

That is, in the sheet conveyance apparatus 84, the pressing force of the third tension spring 110 is variable such that a larger pressing force acts on the outer portion of the end-side driven roller 100E in the conveyance width direction than on the inner portion of the end-side driven roller 100E in the conveyance width direction. Note that, in the sheet conveyance apparatus 84, the pressing force of the third tension spring 110 is variable in two stages, but may also be variable in three or more stages or variable without any stage.

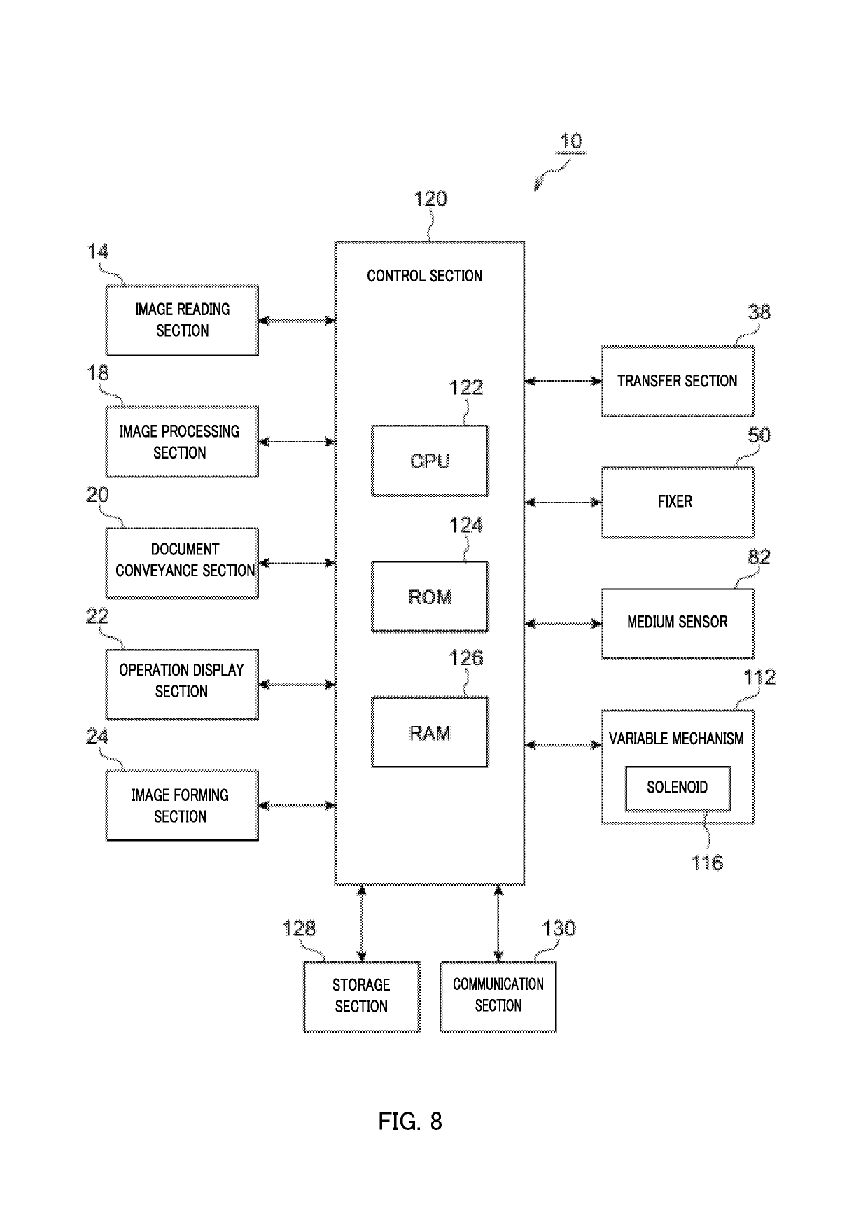

The control configuration of the image forming apparatus 10 according to the present embodiment will be described with reference to FIGS. 1 and 5 to 8. FIG. 8 is a control block diagram of the image forming apparatus 10 according to the present embodiment.

As illustrated in FIGS. 1 and 8, the image forming apparatus 10 includes a control section 120 that controls the image reading section 14, the image processing section 18, the document conveyance section 20, the operation display section 22, the image forming section 24, the transfer section 38, the fixer 50, the sheet conveyance apparatus 84, and the like. The control section 120 plays a role in managing control of the image forming apparatus 10 in its entirety. The control section 120 includes a central processing unit (CPU) 122, a read only memory (ROM) 124, and a random access memory (RAM) 126. A storage section 128, a communication section 130, the medium sensor 82, and the like are connected to the control section 120.

The CPU 122 integrally controls the entire operation of the image forming apparatus 10. The CPU 122 reads various kinds of control programs and setting data stored in the ROM 124, stores the read programs and setting data in the RAM 126, and executes the programs to perform various kinds of arithmetic processing. The RAM 126 provides a working memory space to the CPU 122 and stores temporary data. In addition, the CPU 122 refers to various kinds of data stored in the storage section 128 when performing various kinds of arithmetic processing. The storage section 128 is constituted by, for example, a non-volatile semiconductor memory or a hard disk drive.

The control section 120 transmits and receives various types of data to and from an external apparatus (for example, a computer) connected to a network such as a local area network (LAN), a wide area network (WAN) via the communication section 130. For example, the control section 120 receives a print job transmitted from the external apparatus and causes a toner image to be formed on the sheet S based on image data included in the print job. The communication section 130 is constituted by a communication control card such as a LAN card.

As illustrated in FIGS. 1 and 8, the control section 120 has functions as a sheet information acquirer and a variable controller by executing various kinds of control programs. The functions of the control section 120 as the sheet information acquirer and the variable controller may also be regarded as constituting a part of the sheet conveyance apparatus 84. Then, the configurations of the sheet information acquirer and the variable control of the control section 120 are as follows.

As illustrated in FIGS. 1 and 8, the control section 120 as the sheet information acquirer acquires information on the thickness and/or stiffness of the sheet S detected by the medium sensor 82. The control section 120 may acquire information on the thickness and/or stiffness of the sheet S received by the operation display section 22 through a user’s input operation.

The control section 120 as the variable controller controls the solenoid 116 based on the acquired information on the thickness and/or stiffness of the sheet S such that the pressing force of the third tension spring 110 acting on the outer portion of the end-side driven roller 100E in the conveyance width direction is varied. Specifically, in a case where the acquired information on the thickness and/or stiffness of the sheet S is equal to or less than a predetermined threshold value(s), the control section 120 controls the solenoid 116 such that the movable portion 118 moves from the approach position to the separation position. In other words, the control section 120 controls the solenoid 116 such that the pressing force of the third tension spring 110 is larger than the pressing force of the second tension spring 108 acting on the inner portion in the conveyance width direction.

The predetermined threshold value(s) refer(s) to a threshold value(s) related to the thickness and/or stiffness of the sheet S, which serves as a reference for varying the pressing force of the third tension spring 110. The control section 120 is capable of changing the predetermined threshold value(s) as needed.

The control section 120 as the variable controller may control the solenoid 116 such that the movable portion 118 is switched from the approach position to the separation position after the sheet S is held between the drive roller 86 and the plurality of driven rollers 100. In other words, the control section 120 may control the solenoid 116 such that the pressing force of the third tension spring 110 is larger than the pressing force of the second tension spring 108 after the sheet S is held between the drive roller 86 and the plurality of driven rollers 100. Note that, when the sheet S is detected by a sheet sensor (not illustrated) provided in the vicinity of the drive roller 86, the control section 120 recognizes that the sheet S is held between the drive roller 86 and the plurality of driven rollers 100.

The control section 120 as the variable controller may control the solenoid 116 such that the movable portion 118 is switched from the separation position to the approach position in a state in which the sheet S is held between the drive roller 86 and the plurality of driven rollers 100. In other words, the control section 120 may control the solenoid 116 such that the pressing force of the third tension spring 110 decreases in a state in which the sheet S is held between the drive roller 86 and the plurality of driven rollers 100.

The control section 120 as the variable controller may independently control the solenoid 116 when the drive roller 86 rotates in the forward direction and when the drive roller 86 rotates in the reverse direction. In other words, the control section 120 may independently control the solenoid 116 in a case where the sheet S is conveyed toward the side of the terminal end of the switchback conveyance path 74 and in a case where the sheet S is switched back and conveyed.

According to the configuration of the sheet conveyance apparatus 84 according to the present embodiment, the pressing force of the third tension spring 110 is variable such that a larger pressing force acts on the outer portion of the end-side driven roller 100E in the conveyance width direction than on the inner portion of the end-side driven roller 100E in the conveyance width direction as described above. For this reason, in a case where the sheet S such as thin paper having a low stiffness is conveyed, the pressing force of the third tension spring 110 is varied such that a larger pressing force acts on the outer portion in the conveyance width direction than on the inner portion in the conveyance width direction. Accordingly, albeit illustration is omitted, the end-side driven roller 100E is tilted (displaced) so as to gradually approach the roller shaft 94 outward in the conveyance width direction. Correspondingly, as indicated by the imaginary lines in FIG. 4, the holding portion of the divided roller 92 on the end side in the conveyance width direction is elastically deformed so as to gradually approach the roller shaft 94 outward in the conveyance width direction. As a result, a conveyance vector directed outward in the conveyance width direction is generated by the drive roller 86 and the two end-side driven rollers 100E, a force that stretches the sheet S outward in the conveyance width direction acts, and waviness of the sheet S can be suppressed.

Thus, the sheet conveyance apparatus 84 of the present embodiment makes it possible to stably convey the sheet S with a sufficient conveyance force while suppressing the occurrence of wrinkles and jamming of the sheet S regardless of the thickness of the sheet S.

In addition, according to the configuration of the sheet conveyance apparatus 84 according to the present embodiment, the drive roller 86 and the plurality of driven rollers 100 are disposed in the switchback conveyance path 74 of the reverse conveyance path 72 as described above. That is, the sheet conveyance apparatus 84 conveys the sheet S under an environment in which the stiffness of the sheet S decreases due to the heat of the fixer 50 and the conveyance force by the drive roller 86 and the driven rollers 100 is less likely to be uniformly applied to the sheet S due to the fixing of the toner. As a result, it is possible to suppress waviness of the sheet S more effectively.

Thus, the sheet conveyance apparatus 84 according to the present embodiment makes it possible to suppress the occurrence of wrinkles and jamming of the sheet S more effectively regardless of the thickness of the sheet S.

In addition, according to the configuration of the sheet conveyance apparatus 84 according to the present embodiment, the drive roller 86 rotates in the forward direction and the reverse direction as described above. For this reason, even in a case where the conveyance direction of the sheet S is reversed, a conveyance vector directed outward in the conveyance width direction is generated by the drive roller 86 and the two end-side driven rollers 100E and waviness of the sheet S can be suppressed.

Thus, even in a case where the conveyance direction of the sheet S is reversed, the sheet conveyance apparatus 84 of the present embodiment makes it possible to stably convey the sheet S with a sufficient conveyance force while suppressing the occurrence of wrinkles and jamming of the sheet S.

According to the configuration of the sheet conveyance apparatus 84 according to the present embodiment, the control section 120 controls the solenoid 116 based on information on the thickness of the sheet S or the like such that the pressing force of the third tension spring 110 is varied. For this reason, in a case where the information on the thickness of the sheet S or the like is equal to or less than the predetermined threshold value, the control section 120 controls the solenoid 116 such that the pressing force of the third tension spring 110 is larger than the pressing force of the second tension spring 108 acting on the inner portion in the conveyance width direction. Thus, it is possible to suppress waviness of the sheet S, such as thin paper having a small stiffness, more effectively.

Thus, the sheet conveyance apparatus 84 according to the present embodiment makes it possible to suppress the occurrence of wrinkles and jamming of the sheet S more effectively.

In addition, according to the configuration of the sheet conveyance apparatus 84 according to the present embodiment, the control section 120 is capable of changing the predetermined threshold value as described above. For this reason, even in a situation where waviness of the sheet S is likely to occur due to a change over time in the surface condition of the sheet S or the sheet conveyance apparatus 84, it is possible to suppress waviness of the sheet S, such as thin paper having a small stiffness, by appropriately lowering the predetermined threshold value.

Thus, the sheet conveyance apparatus 84 according to the present embodiment makes it possible to suppress the occurrence of wrinkles and jamming of the sheet S over a long period of time.

In addition, according to the configuration of the sheet conveyance apparatus 84 according to the present embodiment, the control section 120 controls the solenoid 116 such that the pressing force of the third tension spring 110 is larger after the sheet S is held between the drive roller 86 and the plurality of driven rollers 100 as described above. For this reason, it is possible to suppress an inclination of the sheet S, which is held between the drive roller 86 and the plurality of driven rollers 100, with respect to the conveyance width direction.

Thus, the sheet conveyance apparatus 84 according to the present embodiment makes it possible to stably suppress the occurrence of wrinkles and jamming of the sheet S.

In addition, according to the configuration of the sheet conveyance apparatus 84 according to the present embodiment, the control section 120 controls the solenoid 116 such that the pressing force of the third tension spring 110 decreases in a state in which the sheet S is held between the drive roller 86 and the plurality of driven rollers 100 as described above. For this reason, in a case where there are no longer wrinkles of the sheet S during the conveyance of the sheet S, it is possible to suppress a force, which stretches the sheet S outward in the conveyance width direction, from acting more than necessary.

Thus, the sheet conveyance apparatus 84 according to the present embodiment makes it possible to suppress a tear in the sheet S during the conveyance of the sheet S.

In addition, according to the configuration of the sheet conveyance apparatus 84 according to the present embodiment, the control section 120 independently controls the solenoid 116 when the drive roller 86 rotates in the forward direction and when the drive roller 86 rotates in the reverse direction as described above. For this reason, in a case where there are no longer wrinkles of the sheet S during the conveyance of the sheet S by the rotation of the drive roller 86 in the forward direction, it is possible to suppress a force, which stretches the sheet S outward in the conveyance width direction, from acting more than necessary during the conveyance of the sheet S by the rotation of the drive roller 86 in the reverse direction.

Thus, the sheet conveyance apparatus 84 according to the present embodiment makes it possible to suppress a tear in the sheet S during the conveyance of the sheet S.

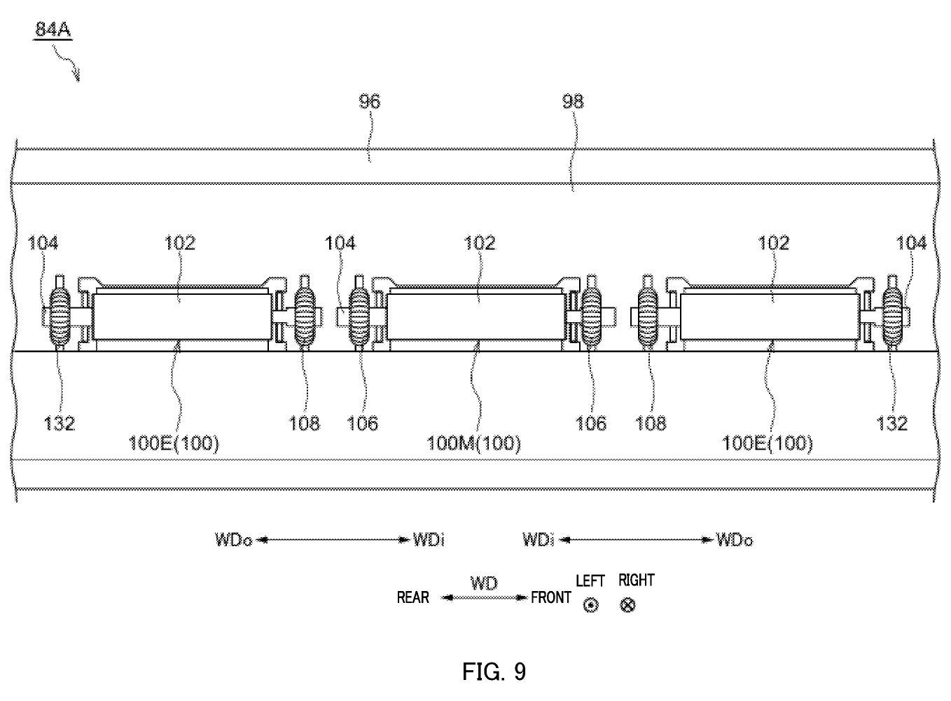

A sheet conveyance apparatus 84A according to Variation 1 of the present embodiment will be described with reference to FIGS. 1 and 9. FIG. 9 is a schematic diagram illustrating a part of the sheet conveyance apparatus 84A according to Variation 1 of the present embodiment.

As illustrated in FIGS. 1 and 9, the image forming apparatus 10 according to the present embodiment may include the sheet conveyance apparatus 84A according to Variation 1 of the present embodiment instead of the sheet conveyance apparatus 84 according to the present embodiment. The sheet conveyance apparatus 84A has the following configurations instead of including the third tension spring 110 (see FIG. 5) and the variable mechanism 112 (see FIG. 5). Note that, for convenience of description, members having the same functions as those described in the present embodiment are denoted by the same reference signs, and the descriptions thereof will not be repeated.

As illustrated in FIG. 9, a fourth tension spring 132 as a fourth pressing member that presses the outer portion of the end-side driven roller 100E in the conveyance width direction to the side of the divided roller 92 is provided at a position corresponding to the outer end portion of the roller shaft 104 of the end-side driven roller 100E in the second guide plate 98. The fourth tension spring 132 may be regarded as a fourth bias member that biases the outer portion of the end-side driven roller 100E in the conveyance width direction to the side of the divided roller 92. Each end portion of the fourth tension spring 132 is locked at an appropriate position of the second guide plate 98. The fourth tension spring 132 comes into pressure contact with the outer end portion of the roller shaft 104 of the end-side driven roller 100E by the elasticity of the fourth tension spring 132. Then, the spring constant of the fourth tension spring 132 is set to be larger than the spring constant of the second tension spring 108.

That is, in the sheet conveyance apparatus 84A, the pressing forces of the second tension spring 108 and the fourth tension spring 132 are set such that a larger pressing force acts on the outer portion of the end-side driven roller 100E in the conveyance width direction than on the inner portion of the end-side driven roller 100E in the conveyance width direction. In addition, the pressing force of the two first tension springs 106 acting on the intermediate driven roller 100M is set to be lower than the pressing forces of the second tension spring 108 and the fourth tension spring 132 acting on the end-side driven roller 100E.

According to the configuration of the sheet conveyance apparatus 84A according to Variation 1 of the present embodiment, the pressing forces of the second tension spring 108 and the fourth tension spring 132 are set such that a larger pressing force acts on the outer portion of the end-side driven roller 100E in the conveyance width direction than on the inner portion of the end-side driven roller 100E in the conveyance width direction. For this reason, albeit illustration is omitted, the end-side driven roller 100E is tilted (displaced) so as to gradually approach the roller shaft 94 (see FIG. 4) outward in the conveyance width direction. Correspondingly, albeit illustration is omitted, the holding portion of the divided roller 92 (see FIG. 4) on the end side in the conveyance width direction is elastically deformed so as to gradually approach the roller shaft 94 outward in the conveyance width direction. As a result, a conveyance vector directed outward in the conveyance width direction is generated by the drive roller 86 and the two end-side driven rollers 100E, a force that stretches the sheet S outward in the conveyance width direction acts, and waviness of the sheet S can be suppressed.

Thus, the sheet conveyance apparatus 84A of the present embodiment makes it possible to stably convey the sheet S with a sufficient conveyance force while suppressing the occurrence of wrinkles and jamming of the sheet S regardless of the thickness of the sheet S.

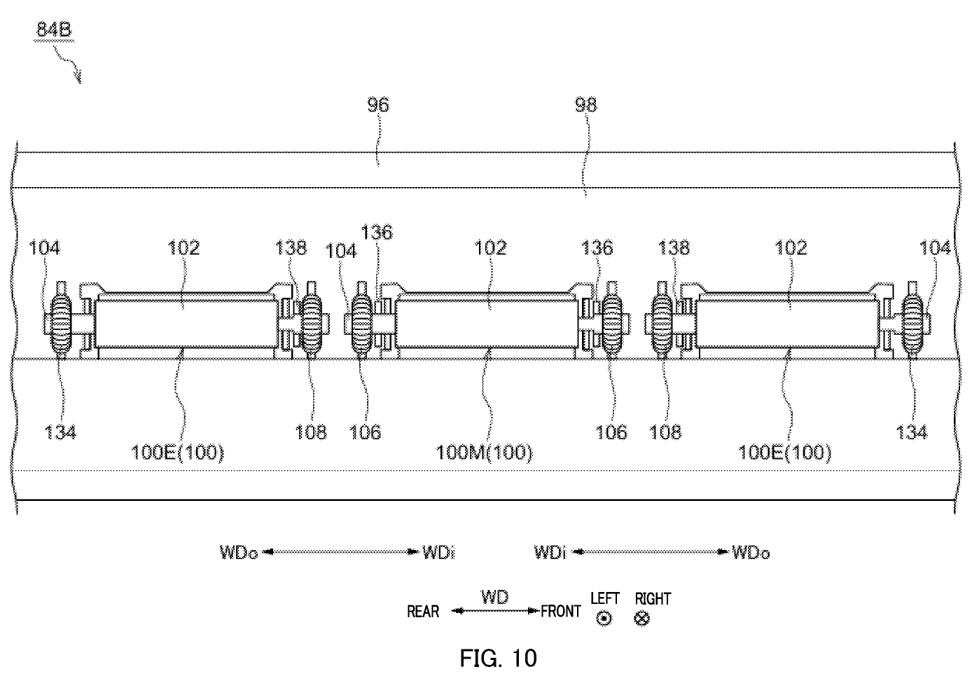

A sheet conveyance apparatus 84B according to Variation 2 of the present embodiment will be described with reference to FIGS. 1 and 10. FIG. 10 is a schematic diagram illustrating a part of the sheet conveyance apparatus 84B according to Variation 2 of the present embodiment.

As illustrated in FIGS. 1 and 10, the image forming apparatus 10 according to the present embodiment may include the sheet conveyance apparatus 84B according to Variation 2 of the present embodiment instead of the sheet conveyance apparatus 84 according to the present embodiment. The sheet conveyance apparatus 84B has the following configurations instead of including the third tension spring 110 (see FIG. 5), and the variable mechanism 112 (see FIG. 5). Note that, for convenience of description, members having the same functions as those described in the present embodiment are denoted by the same reference signs, and the descriptions thereof will not be repeated.

As illustrated in FIG. 10, a fifth tension spring 134 as a fifth pressing member that presses the outer portion of the end-side driven roller 100E in the conveyance width direction to the side of the divided roller 92 is provided at a position corresponding to the outer end portion of the roller shaft 104 of the end-side driven roller 100E in the second guide plate 98. The fifth tension spring 134 may be regarded as a fifth bias member that biases the outer portion of the end-side driven roller 100E in the conveyance width direction to the side of the divided roller 92. Each end portion of the fifth tension spring 134 is locked at an appropriate position of the second guide plate 98. The fifth tension spring 134 comes into pressure contact with the outer end portion of the roller shaft 104 of the end-side driven roller 100E by the elasticity of the fifth tension spring 134. The spring constant of the fifth tension spring 134 is the same as the spring constant of the second tension spring 108 (the spring constant of the first tension spring 106).

A first cushion member 136 is provided at a position corresponding to each end portion of the roller shaft 104 of the intermediate driven roller 100M in the second guide plate 98. Each of the first cushion members 136 is in contact with each end portion of the roller shaft 104 of the intermediate driven roller 100M, and reduces the pressing force of the first tension spring 106 against the intermediate driven roller 100M. Each of the first cushion members 136 is made of, for example, an elastic body such as a sponge.

A second cushion member 138 is provided at a position corresponding to the inner end portion of the roller shaft 104 of the end-side driven roller 100E in the second guide plate 98. The second cushion member 138 is in contact with the inner end portion of the roller shaft 104 of the end-side driven roller 100E and reduces the pressing force of the second tension spring 108 against the inner portion of the end-side driven roller 100E in the conveyance width direction. Each of the second cushion members 138 is made of, for example, an elastic body such as a sponge.

That is, in the sheet conveyance apparatus 84B, the pressing forces of the second tension spring 108 and the fifth tension spring 134 are set such that a larger pressing force acts on the outer portion of the end-side driven roller 100E in the conveyance width direction than on the inner portion of the end-side driven roller 100E in the conveyance width direction. In addition, the pressing force of the two first tension springs 106 acting on the intermediate driven roller 100M is set to be lower than the pressing forces of the second tension spring 108 and the fifth tension spring 134 acting on the end-side driven roller 100E.

Note that, in the sheet conveyance apparatus 84B, the first cushion member 136 and the second cushion member 138 may be omitted. In this case, the attachment position of the fifth tension spring 134 with respect to the second guide plate 98 is set such that the extension amount of the fifth tension spring 134 is larger than the extension amount of the second tension spring 108.

According to the configuration of the sheet conveyance apparatus 84B according to Variation 2 of the present embodiment, the pressing forces of the second tension spring 108 and the fifth tension spring 134 are set such that a larger pressing force acts on the outer portion of the end-side driven roller 100E in the conveyance width direction than on the inner portion of the end-side driven roller 100E in the conveyance width direction. For this reason, albeit illustration is omitted, the roller shaft 104 of the end-side driven roller 100E is tilted (displaced) so as to gradually approach the roller shaft 94 (see FIG. 4) outward in the conveyance width direction. Correspondingly, albeit illustration is omitted, the holding portion of the divided roller 92 (see FIG. 4) on the end side in the conveyance width direction is elastically deformed so as to gradually approach the roller shaft 94 outward in the conveyance width direction. As a result, a conveyance vector directed outward in the conveyance width direction is generated by the drive roller 86 and the two end-side driven rollers 100E, a force that stretches the sheet S outward in the conveyance width direction acts, and waviness of the sheet S can be suppressed.

Thus, the sheet conveyance apparatus 84B according to the present embodiment makes it possible to stably convey the sheet S with a sufficient conveyance force while suppressing the occurrence of wrinkles and jamming of the sheet S regardless of the thickness of the sheet S.

Although embodiments of the present invention have been described and illustrated in detail, it is clearly understood that the same is by way of illustration and example only and not limitation, the scope of the present invention should be interpreted by terms of the appended claims.

What is claimed is:

1. A sheet conveyance apparatus, comprising:
a drive roller which rotates around an axial center parallel to a conveyance width direction orthogonal to a conveyance direction of a sheet;
a plurality of driven rollers which is disposed at intervals in the conveyance width direction, includes a roller body made of a material harder than a material constituting a roller body of the drive roller, cooperates with the drive roller to hold the sheet between the plurality of driven rollers and the drive roller, and is driven to rotate by a rotation of the drive roller; and
a pressing member which presses each of the plurality of driven rollers to a side of the drive roller, wherein
a pressing force of the pressing member is variable or set such that a larger pressing force acts on an outer portion of, among the plurality of driven rollers, an end-side driven roller in the conveyance width direction than on an inner portion of the end-side driven roller in the conveyance width direction, the end-side driven roller being located on each of both end sides of the plurality of driven rollers in the conveyance width direction.

2. The sheet conveyance apparatus according to claim 1, further comprising:
a main conveyance path through which the sheet is conveyed; and
a reverse conveyance path which is branched from a downstream side of a fixer in the main conveyance path and through which the sheet is reversed and conveyed, wherein
the drive roller and the plurality of driven rollers are disposed on the reverse conveyance path.

3. The sheet conveyance apparatus according to claim 2, wherein
the reverse conveyance path includes a guide that regulates a movement of the sheet held between the drive roller and the plurality of driven rollers in a thickness direction of the sheet.

4. The sheet conveyance apparatus according to claim 1, wherein
the drive roller rotates in a forward direction and a reverse direction.

5. The sheet conveyance apparatus according to claim 1, further comprising a variable mechanism that varies the pressing force of the pressing member acting on the outer portion of the end-side driven roller in the conveyance width direction.

6. The sheet conveyance apparatus according to claim 5, further comprising a variable controller that controls the variable mechanism based on information on a thickness of the sheet and/or a stiffness of the sheet such that the pressing force of the pressing member acting on the outer portion of the end-side driven roller in the conveyance width direction is varied.

7. The sheet conveyance apparatus according to claim 6, further comprising a sheet information acquirer that acquires information on the thickness of the sheet and/or the stiffness of the sheet, wherein
the variable controller controls the variable mechanism based on the information on the thickness of the sheet and/or the stiffness of the sheet acquired by the sheet information acquirer such that the pressing force of the pressing member acting on the outer portion of the end-side driven roller in the conveyance width direction is varied.

8. The sheet conveyance apparatus according to claim 6, wherein
the variable controller is capable of changing a threshold value or threshold values relating to the thickness of the sheet and/or the stiffness of the sheet, the threshold value or the threshold values serving as a reference for varying the pressing force of the pressing member acting on the outer portion of the end-side driven roller in the conveyance width direction.

9. The sheet conveyance apparatus according to claim 6, wherein
the variable controller controls the variable mechanism such that the pressing force of the pressing member acting on the outer portion of the end-side driven roller in the conveyance width direction is larger than the pressing force of the pressing member acting on the inner portion of the end-side driven roller in the conveyance width direction after the sheet is held between the drive roller and the plurality of driven rollers.

10. The sheet conveyance apparatus according to claim 6, wherein
the variable controller controls the variable mechanism such that the pressing force of the pressing member acting on the outer portion of the end-side driven roller in the conveyance width direction decreases in a state in which the sheet is held between the drive roller and the plurality of driven rollers.

11. The sheet conveyance apparatus according to claim 6, wherein
the variable controller independently controls the variable mechanism when the drive roller rotates in a forward direction and when the drive roller rotates in a reverse direction.

12. The sheet conveyance apparatus according to claim 1, wherein
the pressing member is a tension spring.

13. The sheet conveyance apparatus according to claim 12, wherein
a spring constant of the tension spring that presses the outer portion of the end-side driven roller in the conveyance width direction is set to be larger than a spring constant of the tension spring that presses the inner portion of the end-side driven roller in the conveyance width direction.

14. The sheet conveyance apparatus according to claim 12, further comprising a cushion member that reduces a pressing force of the tension spring against the inner portion of the end-side driven roller in the conveyance width direction.

15. The sheet conveyance apparatus according to claim 12, wherein
an extension amount of the tension spring that presses the outer portion of the end-side driven roller in the conveyance width direction is larger than an extension amount of the tension spring that presses the inner portion of the end-side driven roller in the conveyance width direction.

16. The sheet conveyance apparatus according to claim 1, wherein
the pressing force of the pressing member acting on, among the plurality of driven rollers, an intermediate driven roller disposed between, among a plurality of the end-side driven rollers, two end-side driven rollers is set to be lower than the pressing force of the pressing member acting on the two end-side driven rollers.

17. The sheet conveyance apparatus according to claim 16, wherein
the roller body of the drive roller is constituted by three divided rollers and a number of the plurality of driven rollers is identical to a number of the three divided rollers, the three divided rollers being three divided rollers into which the roller body of the driving roller is divided along the conveyance width direction.

18. An image forming apparatus, comprising the sheet conveyance apparatus according to claim 1.
